(19) United States
(12) Patent Application Publication
(10) Pub. No.: US 2017/0222868 A1
(43) Pub. Date: Aug. 3, 2017

(54) FAIL-SAFE ELECTRONIC RESTAURANT MANAGEMENT SYSTEM

(71) Applicant: FOODZAPS TECHNOLOGY PTE. LTD., Singapore (SG)

(72) Inventor: Huey Meng Tan, Singapore (SG)

(21) Appl. No.: 15/501,300

(22) PCT Filed: Aug. 12, 2015
(86) PCT No.: PCT/IB2015/056135

§ 371 Date: Feb. 2, 2017

(30) Foreign Application Priority Data
Aug. 13, 2014 (SG) 10201404875Q

(51) Int. Cl. H04L 12/24; H04L 12/26; H04W 24/04; G06Q 50/12; G06Q 30/06

(52) U.S. Cl. CPC H04L 41/0668; G06Q 50/12; G06Q 30/0633; H04W 24/04; H04L 43/0811; H04L 41/12; H04L 41/22

(57) ABSTRACT

Methods for data synchronization in a computer network of a restaurant management system, corresponding devices and a corresponding system. A client receives a selected dish, stores it in a client order list and sends a corresponding synchronization message to a controller, wherein the message comprises a synchronization time and entries of the client order list. The controller receives the message, updates a controller order list accordingly and generates a current synchronization time. The controller receives a second synchronization time from a second client and selects entries from the controller order list, depending on the second synchronization time and on the current synchronization time, and sends a second synchronization message, which contains the selected items, to the second client.

The current specification relates to electronic restaurant management systems.

Currently, electronic devices are used to provide assistance for specific tasks in restaurant businesses. For example, in some restaurants, waiters use PDAs to note down customer orders. Furthermore, it is known that self-service restaurants hand out alert devices, which are connected wirelessly to a restaurant computer. The alert device notifies guests when their dish is ready for collection. In other restaurants, electronic menu tablets are provided that allow guests to choose their order from a menu that is shown on a touch screen display of the menu tablet. After completion of the order, a guest hands over the menu tablet to a waiter of the restaurant. In some self-service restaurants, a display is connected to a cash point of the self-service restaurant, which displays the status of orders that have been entered at the cashier at the cash point.

It is an object of the present specification to provide an improved restaurant management system.

The improved restaurant management system of the present specification covers several tasks in a restaurant business and provides a redundancy such that it can be operated in a fail-safe manner.

In particular, a restaurant management system according to the present specification may provide the following features which are summarized below.
1. The devices, which can be tablet computers, smart phones or PDAs, are connected to the same network, for example to a WiFi or a LAN network. The devices are also referred as “mobile terminal units” (MTUs).
2. According to one embodiment, the devices comprise the same application, which provides several modules, such as a kitchen module, a waiter module, a cashier module, a customer module, an operations manager module etc.;
3. According to one embodiment, the devices have the same data in the sense that all devices have the same data structures which are synchronized among all devices, for example a stock inventory list, a list of a menu/dishes to be made, an order list, wherein order may be associated to a customer etc. The contents of the data structures are the same for all entries which have been synchronized starting from a predetermined time, for example all entries of the present day which have already been synchronized;
4. The devices can be configured according to any role, for example order station, progress station, quick ordering station, cashier, etc.;
5. There is only one controller, which provides a centralized handling of the data traffic between the devices and updates all other devices;
6. This controller works through a protocol, such as a TCP Socket
   a. Devices that do not function as controller are in a client mode and are referred to as clients;
   b. The controller updates the client list with a time stamp;
   c. A device can be assigned or switched to a controller function via an automatic trigger or on purpose through user interaction.

In particular, an automatic assignment of a device to a controller function occurs when the currently used controller device breaks down. In one embodiment, the clients detect a breakdown of the controller in the following way. The controller broadcasts a signal to the devices periodically. When clients do not receive this signal within a pre-determined time period, they assign the controller function to another client device which becomes the new controller. In one embodiment, the new controller is determined by a priority list that is stored in every device.
7. If a new device joins the network, it will only get the updates for the present day's orders;
8. History data is backed up to the cloud server. This frees up memory space and processing power of the devices and reduces the risk of data theft.

### General Layout:

1. a) In one embodiment, the controller has two data tables, an order list table and a client list table. The clients only have one table, the order list table.
   b) According to another embodiment, the devices have a client list table and an order list table.

In particular, the client list may be included among operation settings, such as client priority, printer configuration, table map, and user information, such as credential, role, type of permission etc. According to one embodiment, a software on the device provides a user interface to edit the client list and the other configuration settings on a device. The client list, client priority and optionally other configuration settings are then transferred to the controller, which synchronizes these data to all client devices. On start-up, a controller device builds up the client list from the operation settings and loads the client list into a non-persistent memory, such as a RAM.
2. The client list table contains, among others, the client list synchronization time and the controller priority information and client ID of the clients;
3. The order list table contains, among others
   a. information regarding each unique order
   b. an order creation time
   c. an order update time
   d. an order list sync time;
   e. Order details such as name of dish, quantity, price, special requests, status of dish e.g. Entrée/main course/dessert, wherein one order corresponds to one dish;
   f. A status of the order: live/deleted or backed up to cloud
   g. A status of dish: waiting for confirmation/waiting to be cooked/cooking/cooked/waiting for delivery/delivered/paid/cancelled.

### Controller Handling:

1. A client scans or queries for the controller by sending a query message: “is there a controller out there?”
2. The controller returns an acknowledgement message.
3. The controller checks if the client is authorised. If the device is not authorised, the controller will ask the manager for permission to authorise the device. Nicknames can be assigned to devices;
4. Once permission is granted, the controller sends controller information to the client device;
5. When the clients scan for the controller and the controller is not available, clients will scan for the device next on the client priority list. It will do a round robin to scan the client list;
6. Each client can become a controller according to controller priority information in client list table;
7. Health check mode: the clients will send out a live signal every 10 seconds that says “I am alive”;
8. The controller acknowledges the live signal;
9. If the controller does not receive the live signal from the client, it will give a warning to an operator;
10. If the controller is dead, and the clients do not receive the acknowledgement from the controller, the clients will look for the next controller based on the list (this is an automatic trigger).

### Data Handling:

1. Devices are able to see all other devices in the same sub-net or network group. This is configured in the controller device or, if present, in a dedicated router;
2. Each device has a unique ID, which can be retrieved from software set-up of device. For example, the unique ID can be randomly generated using the MAC address of the network card as the seed;
3. The controller information comprises client list, set up of tables, a list of other devices;
4. A client will send the last sync time to the controller;
5. The client will check if any order has sync time zero. If yes, the client will send order information to the controller;
6. The controller will receive the new order from client with last sync=0. It will update the order list table and the sync time with an actual time stamp and send it back to all devices;
7. The controller will check the client last sync time in the client list table. It will send all entries of the order list which have a sync time before the last sync time;
8. The client updates its order list table with the order list from the controller;
9. If there is no sync time, the controller will send the complete order list table, excluding the deleted items. Once an order comes in, it will be sent to cloud for backup. Alteration of order is possible. At the end of the day, all deleted items will be removed from the device if the backup has been successful;
10. The client will check if any of the order list sync time is zero. If it is zero, it means that the information has not been sent to the controller;
11. The devices can be configured in such a way that they only display the orders that are relevant to them e.g.: kitchen module, waiter module, cashier module (see below for further explanations);
12. The clients will acknowledge an updated order list;
13. The client list table is only provided with an actual sync time upon receipt of acknowledgement. This can be done for batches having a pre-determined number of 5, 10 or more entries, depending on how the client list is configured;
14. A crash of devices can be determined within a predetermined time, for example within 10 seconds, due to a health check mode. Crashed devices can be replaced with any other device just by switching the mode, there is no data lost.

In particular, the receiving and sending of data can be asynchronous on the controller device. When the controller receives new order data, the controller scans its order list table and sends those entries for which the synchronization time is greater than the last synchronization time of the corresponding device. When a client is connected to the controller, it scans its own order list table and sends the last synchronization time of the device to the controller.

In one particular embodiment, the data in the order list table is limited to orders of the present day and/or to orders which are marked as favourite orders.

### Kitchen Module:

1. In a retrieval mode all orders to be done are displayed.

Optionally, the order entries can be filtered by departments or categories such as hot drink, alcoholic drink, salad bar, soup, desserts, main course etc.
2. According to a further modification, the progress status is displayed only if all orders for the previous course status have been delivered. When a status of the orders from the previous course has been updated to “delivered”, a status of the orders of the next course is changed from “waiting to be cooked” to “cooking”.

### Waiter Module:

1. The waiter module comprises a table layout;
2. A user of the waiter module is able to see how many dishes are cooking or have been delivered;
3. If a particular table has waited for more than a predetermined waiting time, the table will turn orange as a warning sign;
4. According to a further embodiment, the waiter module provides information on whether the customer is looking at the dish or not. This feature utilizes the smart tablet face camera movement and the flipping behaviour to determine whether customer needs help from the waiter. This provides information about what the customer wants before the waiter approaches. Waiter is also able to tell which table is looking at the menu, this helps to save time as waiter will go to that particular table instead of looking around.

According to one aspect, the current specification discloses a computer implemented method for synchronizing a dish order list in a computer network of a restaurant management system, wherein the computer network can be provided, in particular, by a computer network comprising a wireless network, or by a wireless network, such as a wireless network according to IEEE 802.11.

A first mobile device in a client mode, such as a handheld device, receives an order for a selected dish by receiving a user selection from a menu list and stores the user selection in a client dish order list. The first mobile device sends a synchronization message to a mobile controller device over the computer network. The mobile controller device is a mobile device, such as a handheld device, which runs in a controller mode.

The synchronization message comprises a synchronization time of a last synchronization of the first mobile device and one or more entries of a dish order list, which is stored on the first mobile device. In particular, the one or more entries are entries that have been changed since the time of last synchronization.

The mobile controller device receives the synchronization message from the first mobile device and updates a local copy of the dish order list based on the received synchronization message, wherein the local copy of the dish order list is stored on the mobile controller device. Furthermore, the mobile controller device generating an actualized synchronization time, and retrieves a synchronization time of a second mobile client device from a device list, wherein the second mobile client device may be the same as the first mobile client device.

The mobile controller device selects entries from the local copy of the dish order list, wherein the selection depends on the synchronization time of the second client device and on the actualized synchronization time. In particular, this comprises selecting entries that have a synchronization time between the synchronization time of the client and the actualized synchronization time. In particular, a synchronization time of a client device can be set to zero if the client device is not yet synchronized for the first time.

The mobile controller device generates a second synchronization message, which comprises the selected items, and sends the second synchronization message to the second mobile client device over the computer network. In particular, the mobile controller device may include a client identifier such as an IP address in the synchronization message and transmit the synchronization message over an antenna of the mobile controller device.

According to a further embodiment, the mobile controller device receives acknowledgment messages from those client devices in the device list for which the second synchronization message has been sent. The mobile controller device updates the synchronization time for the mobile client devices for which the acknowledgement messages have been received.

According to a further embodiment, the mobile controller device waits for the acknowledgement messages from the mobile client devices for a predetermined waiting time and triggers an appropriate action for those client devices for which an acknowledgement message is not received within the predetermined waiting time.

According to a specific embodiment, the mobile controller generates an alert message, and sends the alert message over the computer network. For example, the mobile controller device may send the alert message to a predetermined address, for example to a predetermined e-mail address. According to a further embodiment, the mobile controller device marks an entry of the client device in the device list as inactive, if the client device is not responsive.

Furthermore, a computer program code, or computer readable instruction set, is disclosed for executing the abovementioned synchronization method. The computer program code comprises a graphical user interface “GUI”, and a configuration option to display a task specific GUI, the task being a user-specific task in a restaurant management system, such as a waiter task, a dish order task, a restaurant customer task, a cooking management task, and a cashier task. In other words, the GUI comprises task specific GUIs which are displayed according to a user selectable task.

Moreover, the current specification discloses a computer program code, which is adapted for execution on a handheld computer device, such as a mobile phone, a PDA, or a tablet computer. In particular, the GUI of the computer readable instruction set is adapted for display on the mobile computing device.

Particularly, the current specification discloses a downloadable) software application for execution on a handheld computing device with the abovementioned computer code, which provides an interface for installing the software application on the handheld computing device. Furthermore, the software application may provide an application specific icon and a set of required permissions for running the application. Furthermore, the software application may be configured to running as a user mode software application under an operating system of the mobile device.

Furthermore, the current specification discloses a computer readable storage medium, and in particular, a storage medium of a server for deployment of the computer readable code, which comprises the abovementioned computer readable instruction set.

In a further aspect, the current specification discloses a computer implemented method for determining a controller mobile terminal unit “MTU” in a computer network of a restaurant management system with a plurality of handheld devices, wherein the computer network can be provided, in particular, by a computer network comprising a wireless network, or by a wireless network, such as a wireless network according to IEEE 802.11. In particular, the method can be executed on a mobile client device.

A device list is provided on each of the handheld devices, which comprises identifiers of the handheld devices. A current controller device is determined from among the devices comprised in the device list. Furthermore, it is determined if a current controller device of the device list is responsive.

If it is determined that the current controller device is not responsive, a new controller device is determined according to a device rank that is uniquely associated with each entry in the device list. For example, the devices of the list may be numbered sequentially according to the devices rank. In one particular embodiment, the determination whether a controller device is responsive comprises the following steps.

A mobile client device selects a current controller device from the device list and broadcasts a controller query message across the computer network in pre-determined time intervals.

The mobile client device waits for an acknowledgment message from the current controller device for a predetermined waiting time. If no acknowledgement message is received with in the predetermined waiting time, the mobile client device determines that the current controller is not responsive.

In particular, the controller query message may include a message type identifier indicating that this is a controller query message, an identifier of the current controller, such as the IP address, a unique device ID, a device nickname etc. The device identifier is unique within the local network, which may be provided by a subnet.

In one particular embodiment, the controller device is identified by selecting the device with the next highest device rank from the device list.

According to a further aspect, the method for determining a controller device comprises the following steps. The next controller, which is to assume the controller function, is identified by selecting a device with the next highest device rank from the device list.

If the new controller device is identical to a current device on which the selection step is executed, the current device is set up as a controller. The setup includes updating the local copy of the device list and, after the setup is completed, broadcasting a message indicating that the new controller is operative. In particular, the broadcast message may comprise an updated device list.

Furthermore, the current specification discloses a computer readable code for executing a method for determining a controller device for execution on a handheld computer and a computer readable storage medium, which comprises the computer readable code. In particular, this may refer to a storage medium on a server computer, which is provided for downloading the computer readable code to a handheld device or to another mobile device.

According to a further aspect, the current specification disclose a mobile device, mobile terminal unit or handheld device of a restaurant management system which is configured to operate in a client mode.

The mobile device comprises a display, an input means, such as a touch screen function, a keypad etc., a wireless communication means, such as a transceiver and a communication unit connected to the transceiver, and a computer readable memory, which comprises a client dish order list and a predetermined menu list. Furthermore, the mobile device comprises a computing means, such as a microchip, a microprocessor, or the like. The display, the input means, the wireless communication means, and the computer readable memory are connected to the computing means.

The mobile device is operative to receive an order for a selected dish by receiving a user selection from the menu list, store the user selection in the client dish order list and generate a first synchronization message, which comprises a first synchronization time and one or more first entries of the client dish order list. In particular, this may refer to those entries which have been changed since the first synchronization time.

Furthermore, the mobile device is operative to receive a second synchronization message, which comprises a second synchronization time and one or more second entries of a controller dish order list and to update the client dish order list based on the received second synchronization message.

Furthermore, the current specification discloses a restaurant management system with at least two, a first, and a second, of the abovementioned devices. The first and the second mobile device are configured to exchange synchronization messages over a computer network. Furthermore, the first and the second mobile device each comprise a device list, and the first and the second mobile device are configured to determine a controller device according to a device ranking in the device list. In particular, the determination of the controller device comprises exchanging synchronization messages between the first and the second mobile device and, if present, with other mobile devices of the computer network.

According to a further aspect, the current specification discloses a mobile device, mobile terminal unit or handheld electronic device for a restaurant management system, which is configured to operate in a client mode.

Similarly to the abovementioned device in the controller mode, the device in the client mode comprises a display, an input means, such as touch screen function, keypad etc., a wireless communication means, such as a transceiver and a communication unit, and a computer readable memory.

The computer readable memory comprises a controller dish order list and a device list. Furthermore, the mobile device comprises a computing means, such as a microchip, a microprocessor, or the like. The display, the input means, the wireless communication means, and the computer readable memory are connected to the computing means.

The mobile device is operative to receive a first synchronization message from a first client MTU. The first synchronization message comprises a first synchronization time and one or more order entries of a first client dish order list. The mobile device is furthermore operative to update the controller dish order list based on the received first synchronization message, to generate a current timestamp, and to select zero or more entries from the controller dish order list, wherein the selection is based on the current timestamp and the received first synchronization time.

Furthermore, the mobile device is operative to generate a second synchronization message, which comprises the current timestamp and the selected entries of the controller dish order list.

Moreover, the current specification discloses a restaurant management system with at least two, a first and a second mobile device, which are capable of running in a controller mode.

The first and the second mobile device are configured to exchange synchronization messages over a computer network. The first and the second mobile device are furthermore operative to determine a controller device according to a device ranking in the device list. In particular, the determination of the controller device may comprise exchanging synchronization messages between at least the first and the second mobile device.

The subject of the present specification is now explained in further detail with respect to the following Figures in which

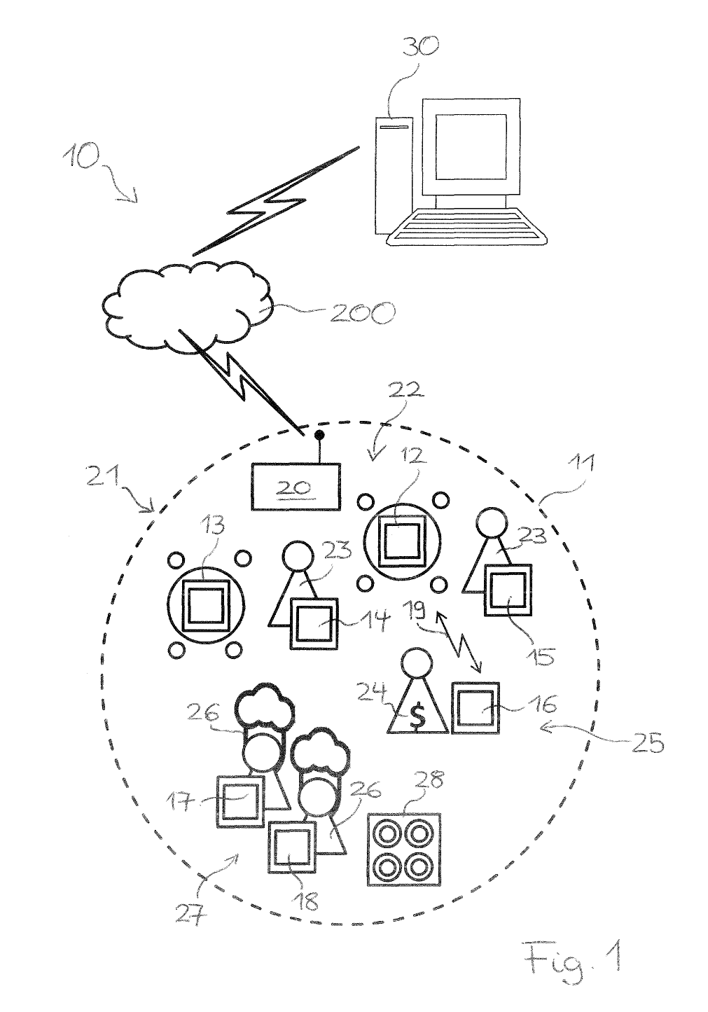

FIG. 1 shows an electronic restaurant management system according to the present specification,

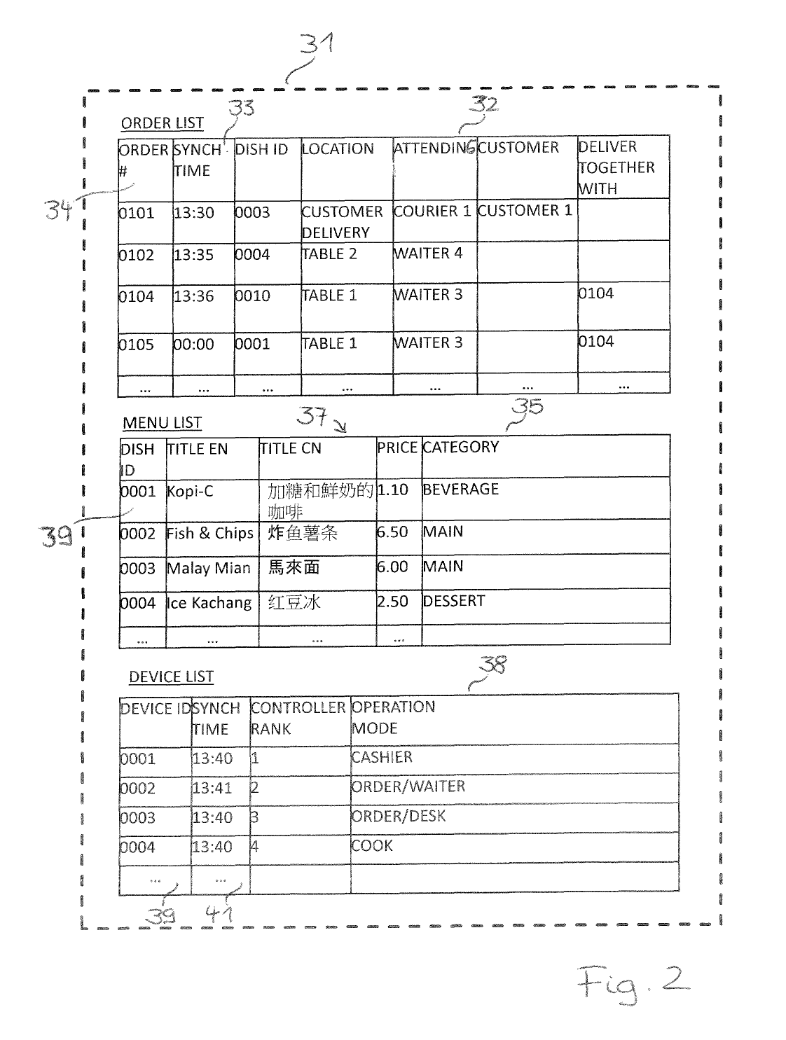

FIG. 2 shows stored data in a memory of a portable device of FIG. 1,

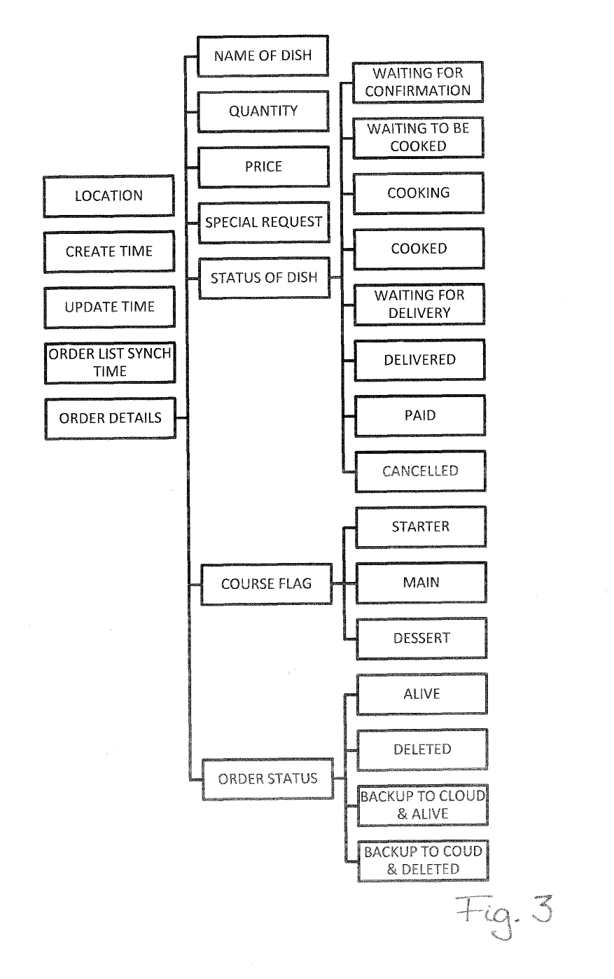

FIG. 3 shows a data structure of an order data entry in the order list of FIG. 2,

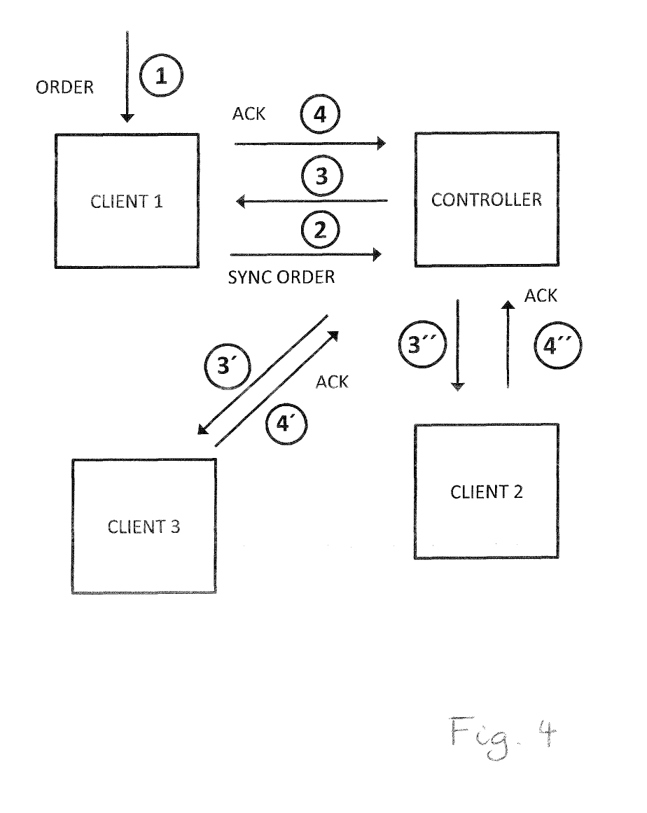

FIG. 4 shows a synchronization procedure in the restaurant management system of FIG. 1,

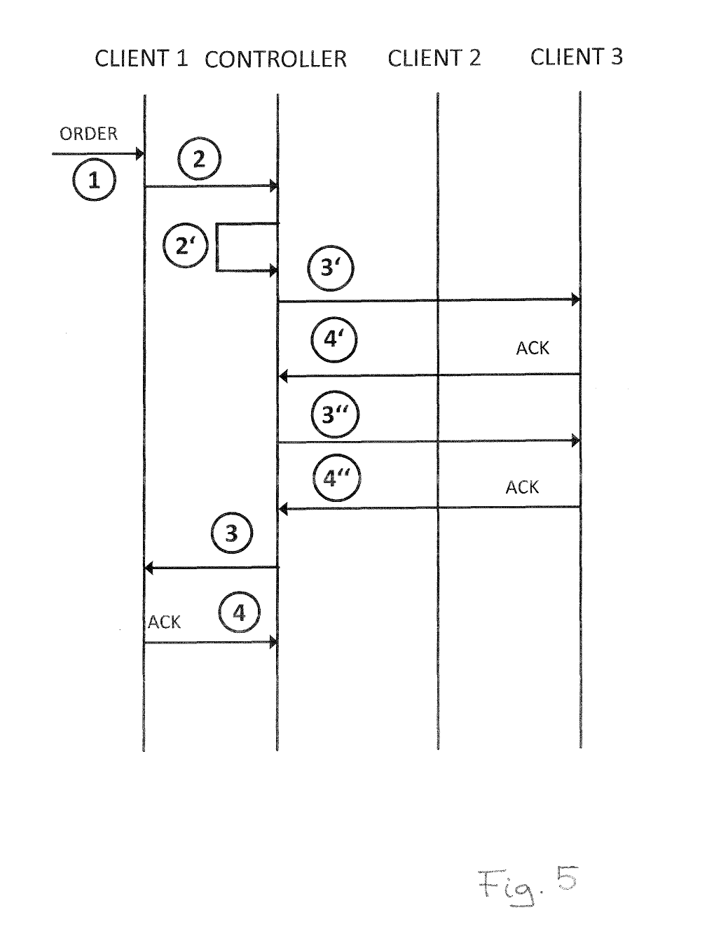

FIG. 5 shows a timeline view of the synchronization procedure of FIG. 4,

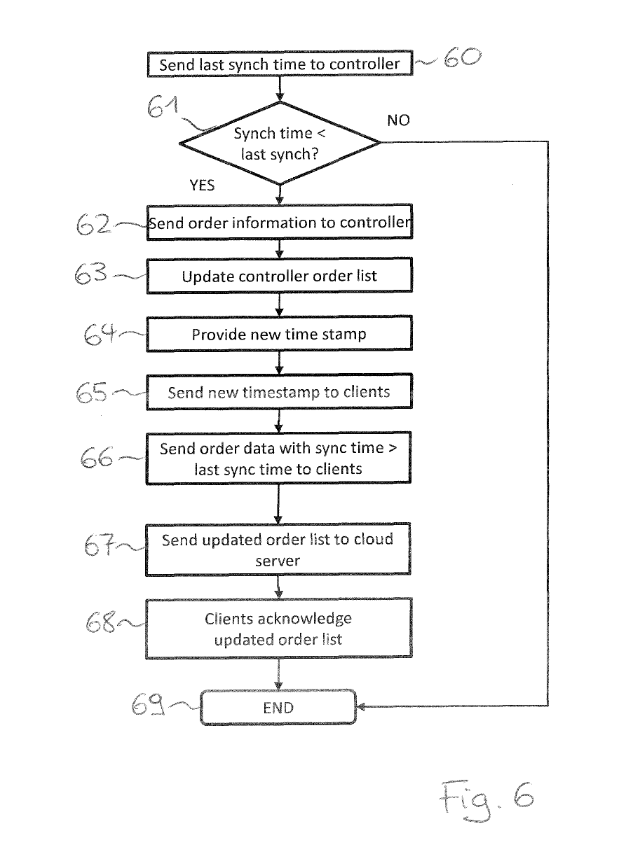

FIG. 6 shows a flow diagram of the order synchronization procedure of FIG. 4,

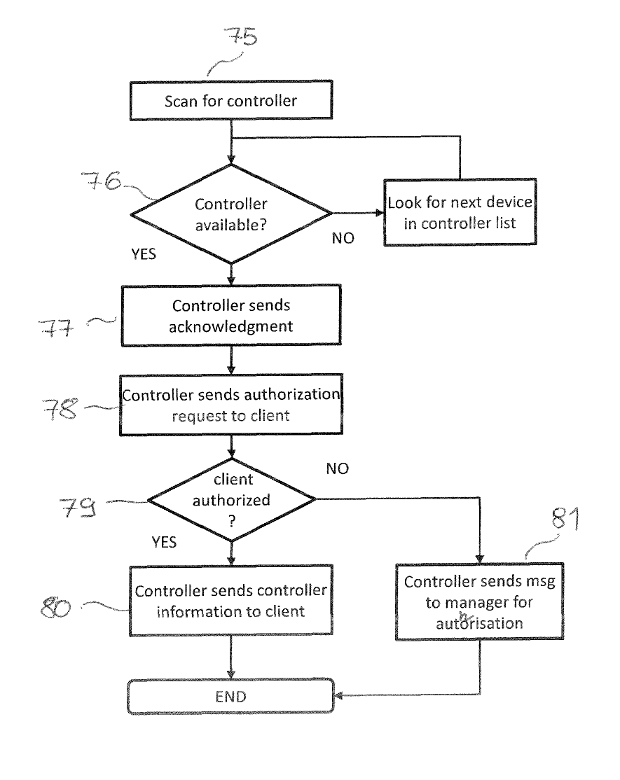

FIG. 7 shows a flow diagram of a controller identification and assignment procedure in the restaurant management system of FIG. 1,

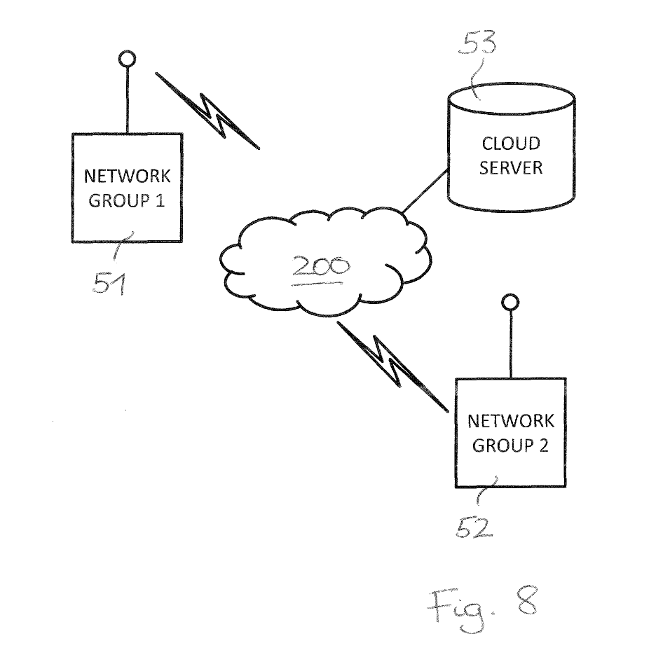

FIG. 8 shows a network layout of the restaurant management system of FIG. 1,

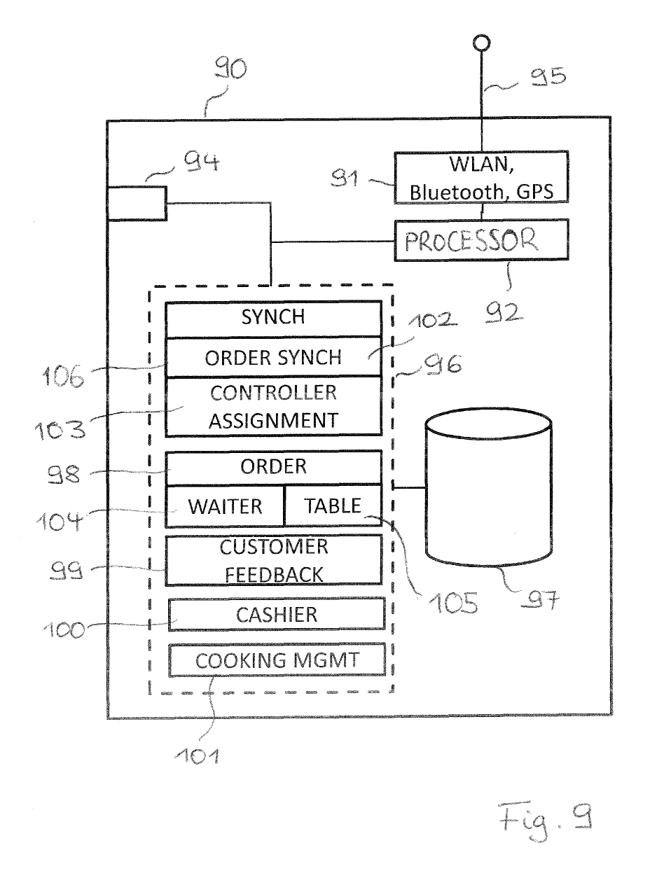

FIG. 9 shows an internal layout of a mobile terminal unit according to the specification,

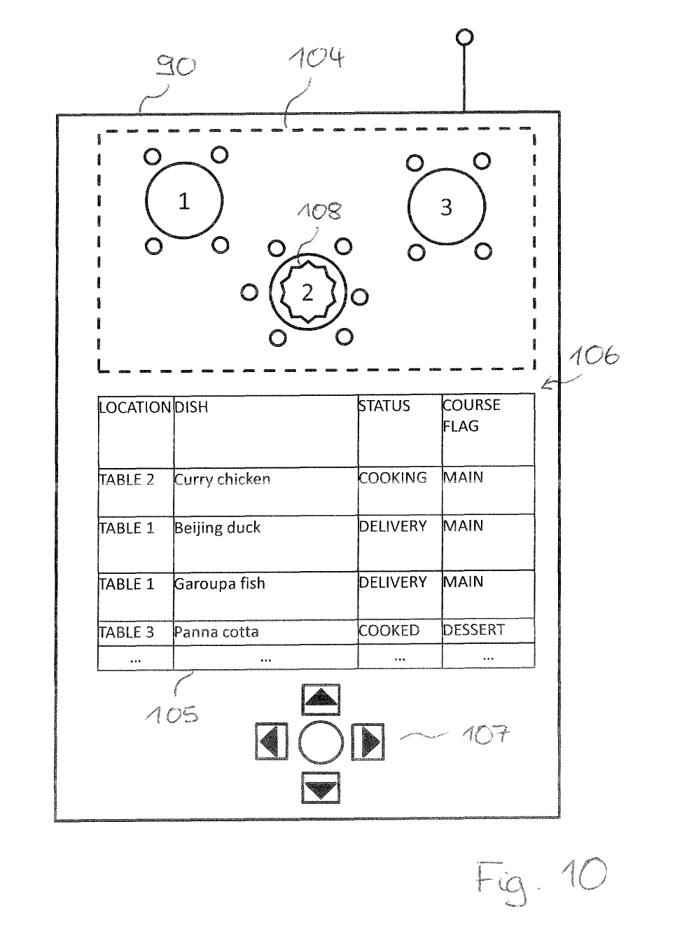

FIG. 10 shows a user interface of a waiter module of a MTU according to FIG. 9,

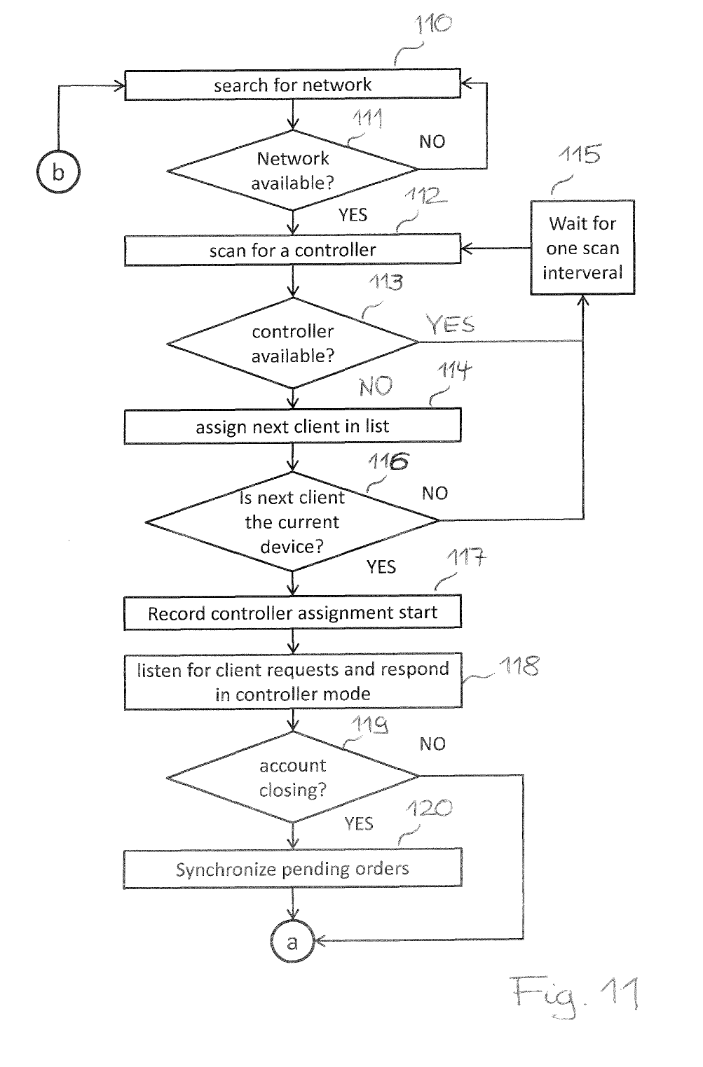

FIG. 11 shows a further controller assignment procedure, and

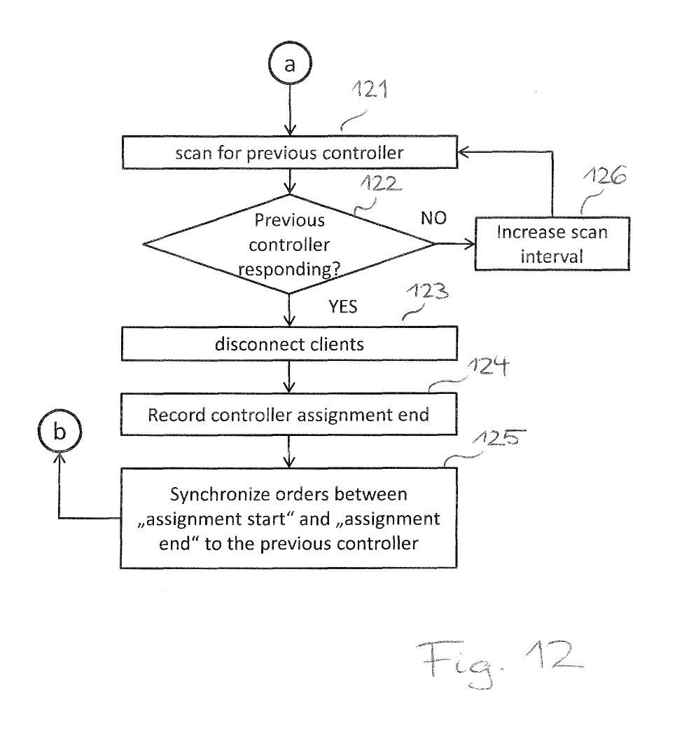

FIG. 12 shows further steps of the procedure of FIG. 11.

In the following description, details are provided to describe the embodiments of the present specification. It shall be apparent to one skilled in the art, however, that the embodiments may be practised without such details.

FIG. 1 shows an electronic restaurant management system 10. The restaurant management system 10 comprises a restaurant area 11 with mobile terminal units (MTUs) 12-18. An MTU 12-18 is a portable electronic device that is provided with a transceiver, which is not shown in FIG. 1. Furthermore, an MTU comprises a display screen, an input facility such as touch screen or a display screen and a keypad, sufficient readable and writable computer memory to hold order data and the like and computing means, such as a microprocessor, for processing the data. In particular, the processing of the data comprises database operations such as creating, deleting, updating and querying data sets.

The MTUs 12-18 form part of a WLAN network 21 and are wirelessly connected to each other over the WLAN network router 20, which is connected to the Internet 200. Furthermore, a supervisor computer 30 is connected to Internet 200, which is connected to the WLAN router 20. The MTUs 12-18 are operative to communicate with each other and with the WLAN router 20 over a wireless connection 19.

Instead of providing a separate router 20, as shown in FIG. 1, one of the MTUs 12-18 may also be used as a router, preferentially the controller MTU. The provision of a separate router, as in FIG. 1, can have the advantage that a router with a higher performance may be used which can be connected to its own power supply. Furthermore, the separate router 20 may be safer against breakdowns and failures than the MTUs 12-18 and it may be installed in a place where it does not get lost or stolen.

First MTUs 12, 13 are provided on tables 8, 9 in a guest area 22 of the restaurant area 11. The first MTUs 12, 13 are configured to run in a menu mode. Second MTUs 14, 15 are individually provided to waiters 23. The second MTUs 14, 15 are configured to run in a waiter mode. A third MTUs 16 is provided to a cashier 24 in a cashier area 25 of the restaurant area 11. In the configuration of FIG. 1, there is only one cashier 24, but there may also be more than one. The third MTUs 16 are configured to run in a cash point mode.

Fourth MTUs 17, 18 are individually provided to cooks 26 in a cooking area 27. The fourth MTUs 17, 18 are configured to run in a cooking management mode. Among others, the cooking area 27 comprises one or more cooking places 28.

One of the MTUs 12-18 is configured to act as a controller MTU. The synchronization is performed via the controller MTU. In this context, the other MTUs are referred to as client MTUs. For example, the MTU 16 may be configured to run as a controller MTU and the other MTUs 12-15, 17, 18 are configured as client MTUs. For the sake of brevity, the client MTUs are also referred to as clients and the controller MTU is also referred to as controller.

In a restaurant management system 10 according to the present specification, the essential data content of the MTUs 12-18 is synchronized to be the same on all MTUs 12. The essential data according to the present specification comprises data content that enables an MTU to be run in any of the provided modes without the need of pulling all the required data from a data provider first. In particular, the essential data comprises at least an order list and a menu list.

In the embodiment of FIG. 1, the provided modes comprise the menu mode, the waiter mode, the cashier mode, and the cooking management mode.

Furthermore, the MTUs 12-18 comprise preferentially software with the same or essentially the same capabilities for all MTUs 12-18 such that any one of the MTUs 12-18 can be configured to run in any provided mode. In one example, a software program is installed on each of the MTUs 12-18, which provides dedicated modules for the respective modes, such as a menu module, a waiter module, a cashier module, and a kitchen module. An MTU 12-18 can then be configured to run in a given mode by activating one module and deactivating the other modules.

In one embodiment, the supervisor computer 30 is provided by a single computer, as shown in FIG. 1. In another embodiment, the supervisor computer 30 is provided by a cloud computing facility. The cloud computing facility may comprise a variable number of computers, according to load demand and available supply of computing resources and those computers may be provided at geographically separate locations, for example in different buildings or even in different towns.

The supervisor computer 30 may comprise further data lists, such as a restaurant inventory list or a list of stored food items in the restaurant, and special purpose software. The special purpose software may be operative, among others, for comparing revenues from different restaurant branches or from different waiters, or between different day times or times of the year, for the ordering of new food items, for the servicing or cleaning of the equipment, for managing regular inspections of the facilities etc.

In one embodiment, the menu module is provided with a capability to detect behavioural patterns and to generate and forward a corresponding notification. For example, the menu module may be adapted to detect when a guest at table 8 scrolls up and down the wine list displayed in the MTU 13 and forward a corresponding message to an MTU 14 of a waiter 23, which is serving the table 8. To this end, the MTU 14 may comprise a list of tables that are served by the waiter 23 holding the MTU 14. The waiter 23 can then decide, based on the feedback from the MTU 13 if he or she wants to give the guest further assistance.

In one embodiment, the menu module provides an option to display the menu in a language that a user can select. In a barrier-free adaptation, the menu module provides capabilities to display the menu in Braille notation in a specially adapted display, to read out the menu to the guest and/or to react to the operation of dedicated control elements provided on the MTU.

According to a further embodiment, the cooking place 28 comprises sensors, a computing device to monitor the state of the dishes and a transmitter to send the status of the dishes to the MTUs. E.g. the computing device may monitor the time when a medium steak needs to be turned or taken from the grill. In a simple embodiment, the cooking place 28 comprises sensors to determine when the food is placed on the cooking place and which heat the cooking place is adjusted to. In a more elaborate embodiment, the cooking place also comprises further sensors, such as visual and/or infrared sensors for determining the current preparation state of the dish.

According to further embodiments, large, easy to read displays are wirelessly connected to the MTUs 17, 18 in the cooking area and/or to the MTUs 16 in the cashier area and are adapted to display the relevant information to the cashier 23 or to the cooks 17, 18, respectively.

According to one embodiment, the assignment of one MTU to a controller function is performed in the following way. All client MTUs scan in regular intervals for the presence of a controller MTU. If there is a functioning controller MTU, the clients receive an acknowledgement message from the controller MTU within in a predetermined time.

In a further embodiment, which is not shown in FIG. 1, the MTUs 17, 18, 16 of the cooks and of the cashier are connected to the network of the router 20 via cable. The MTUs 17, 18, 16 may also be replaced by stationary electronic devices with the same functionality such as PCs, an electronic cash register with a display, or as screens with an attached microprocessor.

FIG. 2 shows a portion of a typical data content in a database 31 in one of the MTUs 12-18. The database comprises, among others, an order list 32 with unique order IDs 33 and order synchronization times 34, a menu list 35 with dish IDs 36 and further information 37, such as a picture of the dish, a prize etc., a client MTU list 38 with client IDs 39 and client synchronization times 41. The client IDs 39 correspond uniquely to one of the MTUs 12-18.

The order list 32 comprises further information such as a location to which the dish is going to be served, an identifier of a person in charge of delivering the dish, a field indicating which dishes are to be delivered together. In the case of a home delivery, the order list entry also comprises a customer identifier, which is linked to a delivery address.

Likewise, the menu list comprises further information about the dish such as the list price, a title of the dish, which may be provided in multiple languages, a category, a link to a picture, further categories such as vegetarian, spicy, low sugar, halal, expected cooking time.

The data content of a MTU 12-18 may be stored, by way of example, in a relational database, an object oriented database or in other data structures and in various formats such as text based, XML based, binary or others. The data content may also be spread out over several data structures, for example as 1 to n, n to 1 or n to m relationships of a relational database. In particular, data content that is spread out over several lists or tables may be referred to as one list or one table, for simplicity.

FIG. 3 shows the order list 32 of FIG. 2 in greater detail. The first two hierarchy levels of FIG. 3 refer to data fields of the order list 32, while the lowest hierarchy level of FIG. 3 lists possible values that some of the fields can take.

An order entry comprises a location, such as “table 1”, an order creation time, an order update time, an order synchronization time and further order details, such as the name of the dish, the ordered quantity, for example pieces or weight, the prize per unit of quantity, a special request field, a course flag and an order status.

By way of example, the status of the dish may take on the following statuses: “waiting for confirmation”, “waiting to be cooked”, “cooking”, “cooked/ready”, “waiting for delivery”, “delivered”, “paid”, “cancelled”, the course flag may take on the values “starter” or “entrée”, “main” and “dessert” and the order status flag may take on the values “alive”, “deleted”, “backup to cloud and alive” or “backup to cloud and deleted”.

FIG. 4 shows a synchronization process of the restaurant management system 10 of FIG. 1, wherein a client MTU 13 receives an order, which is subsequently synchronized to the other MTUs. By way of example, only the MTUs 13, 14, 16, 18 are shown in FIG. 4.

In a step 1, the client MTU 13 receives an order, for example by a guest at a table entering the order in a user interface of the menu module or by a waiter entering the order in a user interface of the waiter module.

In a step 2, the client MTU 13 forwards the order data to MTU 16, which acts as controller. The forwarding of the order may be triggered automatically after a user has entered the order, a predetermined time interval after entry of the order or after a user has manually initiated a data transfer over the user interface.

The MTU 16 stores the order data and updates the sync time with an actualized timestamp ‘NOW’. In a step 2′, the controller MTU 16 checks the client list Table 38 of FIG. 2 and forwards the order to those clients whose sync time is less than ‘NOW’.

In a step 3″, the controller MTU 16 forwards the order data to the client MTU 14. The client MTU 14 stores the order data and sends back an acknowledgment message to the controller MTU 16 in a step 4″. The controller MTU 16 will then update the sync time 41 for the client MTU 14 to ‘NOW’.

Likewise, the controller MTU 16 forwards the order data to the client MTU 18 in a step 3′. The client MTU 18 stores the order data and sends an acknowledgement message back to the controller MTU 16 in a step 4′. The controller MTU 16 will then update the sync time 41 for the client MTU 18 to ‘NOW’. The controller MTU 16 repeats the step 3′ of synchronizing the order data for all remaining MTUs in the client list 38 until the sync time of all MTUs is equal to ‘NOW’. In other words, the step 3′ is repeated until the controller MTU has received acknowledgement messages 4′ from all clients.

The data transfers between the MTUs 12-18, which are symbolized by arrows in FIG. 4, are preferentially carried out over wireless connections. Instead of a cloud server, a dedicated server may be used as well. In particular, a cloud server may refer to a virtual server, which is provided by a plurality of server computers of a server farm or even by computers at different locations. The allocated resources of the cloud server may be provided dynamically, depending on the current load and/or according to configuration data, or they may also depend on other factors such as a payment scheme for the cloud server.

FIG. 5 shows a timeline view of the synchronization process of FIG. 4. In the timeline view of FIG. 5 a message transfer over a wireless connection is indicated by an arrow and a time axis is directed from top to bottom.

FIG. 6 shows a flow diagram of the synchronization process of FIG. 4. In a step 60, a client MTU sends the time of its last synchronization to the controller MTU. In a step 61, the client MTU queries for unsynchronized orders in its local computer memory. In one embodiment, unsynchronized orders are marked by a synchronization time “00:00”. Thereby, a need to synchronize the data can be detected just by comparison of synchronization times, without the need of a further decision step. However, any other synchronization time value that is reserved for this purpose or a synchronization status flag may also be used.

If it is detected in step 61 that there are any unsynchronized orders, the client MTU sends the order information of the unsynchronized order to the dedicated controller MTU in a step 62.

The controller MTU updates its copy of the order list in the local memory of the controller MTU in a step 63. In a step 64, the controller MTU generates a new time stamp for the order data that is to be synchronized. According to one embodiment, the controller MTU provides the order data to be synchronized with the new time step before sending the order data to the client MTUs in step 66. According to another embodiment, the controller MTU provides the local copy of the order data with the new time stamp after successful synchronization in step 68.

In a step 65, the controller MTU sends the newly generated time stamp to the client MTUs. In a step 66, the sends the order data that is to be synchronized to the client MTUs. In the example of FIG. 6, this relates to the order data, which has, or is to receive, a time stamp that is later than the time stamp of the last synchronization of order data.

In a step 67, the controller MTU sends the updated order list to a cloud server, for example to the supervisor computer 30 shown in FIG. 1. In one embodiment, the controller MTU sends the complete updated order list to the cloud server and according another embodiment the controller MTU sends an incremental update of the order list to the cloud server. The update method used by the controller MTU may also be configurable.

In a step 68, the clients update their local copy of the order list and send an acknowledgement back to the controller MTU before the synchronization process ends in step 69. The order data may be synchronized each time when a new order arrives or also in batches of several orders such as 5, 10, or more orders or in response to a synchronization signal that is triggered by a user of the client MTU.

FIG. 7 shows a flow diagram of a controller identification and assignment process according to the present specification. In a step 75, a client MTU starts a scan for a controller MTU by sending query messages over a wireless connection. If a controller MTU is available in step 76, that controller MTU sends an acknowledgment message back to the client MTU in step 76. Furthermore, the controller sends an authorization request to the client in step 78. If it is detected in step 79 that the client is authorized by using a suitable authorization procedure, the controller sends controller information such as IP address, device model, device manufacturer, Unique ID, Nickname back to the client in step 80.

If, in step 76, the dedicated controller MTU is not available, the client looks up the next device in its local copy of a controller list, which is also called “controller priority list”, and checks if this MTU is available until the client MTU finds an available MTU. The available MTU detects from the query message that it is to become the controller MTU, switches to a controller mode and broadcasts this information to the other MTUs, which update their local copies of the controller list.

If the client MTU cannot authorize itself in step 79, the controller MTU sends a request for authorization to a manager in a step 81, wherein “manager” may refer to a managing program or to a person who receives the authorization request through an interface of an electronic device.

The clients query in pre-determined time intervals, in step 75, if a controller is available. According to one embodiment, the pre-determined time intervals last about 10 seconds, and in particular 8 to 12 seconds. The regular querying in step 75 is also referred to as “health check mode”.

According to a further modification to this embodiment, the controller MTU checks if it has received query messages from all client MTUs. To this end, a sender identifier is included in the query message, which a client MTU sends to query for a controller MTU. If the controller MTU does not receive a query message from a client MTU within a pre-determined time, it triggers a pre-determined action such as sending a notification to an operator.

Further use cases, which are handled by a restaurant management system 10 according to FIG. 1, include, among others, replacement of one MTU with another, configuration of a new MTU, and collective delivery to one table.

According to a first use case, a first MTU 16 in a cashier mode fails and a second MTU 13 in a menu mode is used to replace the first MTU 16. A worker of the restaurant sets the MTU 13 into a cashier mode. This may be done in one of several way, for example over a configuration menu, by rebooting and selecting a corresponding option or via remote reconfiguration over the wireless connection or over a data cable.

After the mode change to the cashier mode, the MTU 13 triggers a synchronization of a database in a memory of the MTU 16 and pulls, if necessary, additional data, which is needed for operation as cashier. In this case, the MTU 13 sends a request to a data source such as one of the other MTUs or the supervisor computer 30.

In particular, the MTU 13 may pull the additional data from another MTU, which is already configured as cashier. In one embodiment, the information which orders have already been billed is kept in a “paid” status flag of the order table, such as the paid flag of FIG. 3 and is automatically transferred during the synchronization of the order list table. If the MTU 16 needs information about orders, which have already been transferred to the supervisor computer and have been deleted from the order list, which is mirrored in the data memories of the MTUs, the MTU 13 sends a request to the supervisor computer 30 to transfer the required data to the MTU 13.

The cashier mode presents a view on the data and data manipulation options, which are specific to the cashier mode. Furthermore, there may be data manipulation options, which require a special code word, such as the option to cancel wrongly billed dishes. The mode specific view on the data and the data manipulation may also be user configurable according to user preferences or according to company policies. For example, the placement of entry buttons on a touch screen may be different for left and right-handed users. According to a further option, a wireless or a wired physical keyboard can be connected to the MTU for easier data entry.

If the failed cashier MTU has been in the controller mode, the clients no longer receive messages indicating that the controller is alive and assign a new controller. With reference to FIG. 2, this controller function is assigned to the device with the next lower controller rank, in this case device 0002. Furthermore, the MTUs mark the failed device in the device list as inactive or remove it from the device list, such that the failed device is not considered anymore when the new controller device also fails or is taken out of use.

According to a further modification, a user may configure the MTU to take on the role as a controller. In this case, all other MTUs are notified and update their device lists, for example by renumbering the controller rank. If there is already another controller device active, it changes from controller mode to client mode in response to the message of the manually assigned controller device.

According to a further use case, one of the MTUs 17, 18 in the cooking management mode is replaced by one of the MTUs 12, 13 in the table mode. Similarly, to the above use case, the MTU 13 is switched into the cook management mode, in which the cook management module is activated. The cook management mode includes a mode specific view on the data and provides those data manipulation options, which apply to the cooking management mode, such as the ability to set the dish status flag of FIG. 3.

According to a further use case, a new client MTU is added to the WLAN network. An operator uses the functionality of the new client MTU to log into the WLAN network. After that, the operator establishes a wireless data connection to the supervisor computer 30 and downloads and installs a restaurant management software according to the present specification. The download and installation may require a further authorization.

The restaurant management software is set into the required mode, such as the waiter mode, the cashier mode etc. This can be done, for example, during the software installation or at the first start of the restaurant management software. After the first start of the restaurant management software, the new MTU downloads the required data from the controller MTU, in particular the order data for the present day, and determines which MTU is presently the controller device.

According to a further use case, according to which several dishes are served at the same time, a waiter enters which dishes are to be served together. In a simple example, dishes to be served together are identified as the dishes of the same table that have the same course flag, for example all main course dishes for table 1. According to another embodiment, the dishes to be served are marked in the order list, for example by providing a “DELIVER TOGETHER WITH” field, as in the order list of FIG. 2.

If one of the dishes is ready, the flag of the dish is set to “cooked”, either automatically or manually by the cook. An appropriate action is triggered, such as alerting the cook to keep the dish warm or automatically moving the dish to a hot plate. The cooking management module of an MTU 17, 18 detects when all dishes, which are marked to be served together, are cooked. The flag of the dishes is then set to “waiting for delivery”.

When the order lists of the MTUs are updated in regular time intervals, the order list of a waiter's MTU is also updated. The waiter module of a waiter's MTU detects that dishes are ready for collection and displays the dishes accordingly, for example by moving them to the top of a displayed order list and/or by highlighting them by a special colour and/or by generating an acoustic signal.

In particular, the dishes may be associated to a waiter, for example by providing a “waiter” flag in the order list, as shown in FIG. 2.

According to another embodiment, the cook management module alerts the waiter independently of the order list update, and automatically sends an alert message from a MTU of a cook to a MTU of a waiter to collect the dishes.

FIG. 8 shows a network layout of the restaurant management system 10 of FIG. 1. A first network group 51 and a second network group 52 are wirelessly connected to the Internet 200 which is in turn connected to a cloud server 53 by a wired or a wireless connection or a combination thereof.

By way of example, the cloud server 53 can be provided by the supervisor computer 30 of FIG. 30 and the first network group 51 may comprise the MTUs 12-18, as shown in FIG. 1. In one example, the network groups are provided by IP-subnets, which are assigned to the same higher level IP address. Preferentially, all devices in the same subnet are able to detect each other.

In one embodiment, the subnets correspond to different branches of a restaurant chain. According other embodiments, the subnets correspond to different departments of the same restaurant within the same building, such as a hotel bar and a hotel dining hall, or even to independent business entities, for which the subnets 51, 52 and the cloud server 53 provide a common service infrastructure.

In a further embodiment, the MTUs are adapted to work in a self-service restaurant without waiters. In this case, there is no waiter mode and the menu mode provides the additional functionality to place orders to the kitchen. Furthermore, the menu mode may provide an alert functionality that indicates to the guest when a dish is ready for collection.

The MTUs may be provided with functionality to secure them against theft. For example, some of the MTUs may be firmly attached to restaurant furniture, the MTUs may be provided with RFID tags, the MTUs may be adapted to send or estimate a current location of a client MTU, or the MTUs may be provided with only a reduced functionality so that there is only little incentive to take them away.

FIG. 9 shows, by way of example, an internal layout of an MTU 90 according to the present specification, which corresponds to one of the MTUs 12-18 of FIG. 1.

The MTU 90 comprises a wireless communication unit 91 with a transceiver that is connected to an antenna 95, such as a patch antenna or a rod antenna. The wireless communication unit 91 is connected to a microprocessor 92, which may comprise one or more cores. The microprocessor 92 is connected to a USB-socket 94, to a program memory 96 and to a data memory 97. The program memory 96 comprises, among others, a synchronization module 106, an order module 98, a customer feedback module 99, a cashier module 100 and a cooking management module 101. The data memory 97 comprises, among others, the order list of FIG. 2.

The synchronization module 106 comprises a first submodule 102 for handling order synchronization and a second submodule 103 for the assignment and identification of a controller MTU. The order module 98 comprises a waiter submodule 104 and a table or costumer submodule 105.

The number and the hierarchy of the modules and submodules according to FIG. 9 is provided by way of example only. In one embodiment, the modules are provided by a computer readable code of a mobile phone applet, which is entirely or partially loaded in a read and write memory of the MTU, such as a flash memory, a DRAM, a SRAM memory etc.

In one embodiment, the connections between the processing unit, the CPU, the communication unit, the database, and the USB socket are provided by a data bus. In another embodiment, separate data buses are provided for program instructions and for other data.

FIG. 10 shows, by way of example, a user interface of a waiter module according to the present specification. A table layout and a list of dishes to be served to the tables is displayed in a touch screen area 106 of the MTU 90. A track ball and directional keys are provided in a control panel 107 of the MTU 90.

In the example of FIG. 10, table 2 is highlighted because a waiting time exceeds 30 minutes. The waiting time may be determined as the time between setting a dish status to “waiting to be cooked” and the present time. For this purpose, the beginning of a waiting time is recorded in a memory of the MTU 90, for example in a data field of the order list 32.

In further embodiments, the control panel 107 of the MTU may comprise further control elements, such as a keypad, special function keys, an infrared sensor, a fingerprint sensor, or a camera. The camera may be used for detecting user behaviour or for scanning barcodes of packaged items, which are sold to the customer, such as take-away dishes and drinks. Furthermore, the MTU may comprise a magnetic card reader or a socket for connecting a magnetic card read for reading in information from credit cards, discount cards or other magnetic strips. The MTU may also comprise means for wireless reading of a credit card or for transferring money over a wireless connection.

FIGS. 11 and 12 show a further controller assignment procedure according to the current specification.

In a step 110, a client device checks if a pre-assigned network is available. For example, the client scans or queries for a service set identification (SSID) of 802.11 type WLAN, which is stored on the client device.

If the client device detects, in a step 111, that the pre-assigned network is available, the client scans for a controller device in a step 112. Otherwise, the client continues to search for a network in step 110.

If the client device detects, in a step 113, that a controller is not available, for example if no controller response is received within a predetermined waiting time, the client assigns the next client in a stored device list to the controller function in a step 114. Otherwise, the client device waits for one san interval, in step 115, and continues to scan for a controller in step 112.

If the client device detects, in a step 116, that the client device is the new controller device, the client device records a controller assignment start time in step 117, switches to a controller mode, and listens and responds to requests of client devices in controller mode in a step 118. Otherwise, the client device forwards requests, such as dish order synchronizations, to the new controller device. Furthermore, it waits for one scan interval in step 115 and continues to scan for a controller device in step 112.

A controller device determines, in a step 119, if a condition for closing the account for the day is fulfilled, for example by receiving a user input. If the controller device determines, in step 119, that the account is to be closed, it triggers a synchronization of pending dish orders in step 120.

In a step 121 a present controller device, which has taken over controller function from a previous non-responsive controller device, scans for the previous controller device. If the present controller device detects, in a step 122, that the previous controller device is responsive again, the present controller device disconnects the client devices in step 123, for example by broadcasting a message that it is no longer the controller device, records a controller assignment end time in step 124 and synchronizes, in a step 125, all orders with update times, or synchronization times, that are between the assignment start time and the assignment end time to the new controller device. According to a further modification, the client device, which has taken over controller function, also transmits the number of pending order to the previous controller device.

The device that has ceased to be the controller device scans for a network in step 110. If, in step 122, the current controller device detects that the previous controller device is still not responding, the current controller devices increases a scan interval in step 126, waits for the scan interval and continues to scan for the previous controller in step 121. For example, the scan interval is increased to 30 seconds. For simplicity, a condition on which step 126 is executed is not shown. For example, the scan interval may be increased only once, it may be increased before executing step 121 for the fifth, tenth and fifteenth time etc.

If a controller device is the original controller device, which is ranked highest in the device list, steps 121 to 126 are not executed, as there is no need to update the previous controller device in this case.

According to one embodiment, only a master controller device, which is ranked highest in the device list, has the permission to back up the order list to the server 30, 53. According to this embodiment, a user needs to manually configure the current controller device to become a master controller device, if the master controller device cannot be recovered.

According to a further embodiment, a column “update time” is provided in the device list. According to one mode of use, this column is used when a MTU leaves the network and works as a standalone device, for example for delivery purpose. According to another mode of use, this column is used when one or more MTUs leave the master network and run in another network, for example for use during an exhibition.

According to another embodiment, the MTUs are provided with a functionality to export synchronization messages, such as order list updates, in a structured text format, such as JSON or XML. By way of example, this export option can be used to import the synchronization message to one of the MTUs of the network when an MTU is not able to join the network.

According to one embodiment, the assignment of a controller function to a client device causes the new controller device to initiate a synchronization of all pending orders. In particular, the pending orders can be marked by a synchronization time zero, “00:00”.

The embodiments can also be described with the following lists of elements being organized into items. The respective combinations of features, which are disclosed in the item list, are regarded as independent subject matter, respectively, that can also be combined with other features of the application.

In the following, a mobile terminal unit can be provided by a handheld device, such as a mobile phone or a PDA or by other portable electronic devices, such as notebook, notepads, and laptops. An input facility may be provided by a touch screen function, a screen and a keypad or other input devices such as track balls, touch sensors and the like. A computing means can be provided, by way of example, by a microchip, a single core processor, a multi core processor, and so forth. Preferentially, the messages are sent, received, and exchanged over a computer network. In particular, a computer network can be provided by a computer network comprising a wireless network, or by a wireless network, such as a wireless network according to IEEE 802.11.
1. A mobile terminal unit “MTU” for a restaurant management system, comprising
   a display,
   an input facility,
   a computing means,
   a transceiver,
   a computer readable memory, the computer readable memory comprising a client list with a device ranking, and the MTU being operative to
   determine if a controller device of a computer network is responsive,
   if the controller device is not responsive
   determine a new controller device according to the device ranking.
2. The MTU according to item 1, the MTU being operative to
   broadcast a controller query message in predetermined time intervals over a computer network,
   wait for a an acknowledgement message to the controller query message for a predetermined time,
   determine that the controller device is not responsive if no acknowledgement message is received within a predetermined waiting time.
3. An electronic restaurant management system, the electronic restaurant management comprising
   a first mobile terminal unit “MTU” and
   a second mobile terminal unit “MTU”, wherein the first MTU is configured to run in a first operational mode and the second MTU is configured to run in a second operational mode, the first operational mode and the second operational mode being related to a user specific task in a restaurant management system.
4. An electronic restaurant management system with a first mobile terminal unit “MTU” and a second mobile terminal unit “MTU”,
   the first MTU comprising a computer readable memory with a first dish order list, and
   the second MTU comprising a computer readable memory with a second dish order list,
   the first MTU and the second MTU being operative to synchronize the first dish order list with the second dish order list over a wireless connection.
5. An electronic restaurant management system comprising
   a first mobile terminal unit “MTU”,
   a second mobile terminal unit “MTU”, and
   a third mobile terminal unit “MTU”,
   the first MTU comprising a first dish order list and a device list, the second MTU comprising a second dish order list and the third MTU comprising a third dish order list,
   the first MTU being configured to run in a controller mode, the second MTU and the third MTU being configured to run in a client mode,
   the second MTU being operative to send a first synchronization message from the second MTU to the first MTU, the first synchronization message comprising a synchronization time and one or more entries of a dish order list, the first MTU being operative to
   receive the first synchronization message,
   update the first dish order list based on the received synchronization message,
   generate an actualized synchronization time,
   retrieve a synchronization time of the second MTU from the device list,
   select entries from the first dish order list, the selection depending on the synchronization time of the second MTU and on the actualized synchronization time,
   generate a second synchronization message, the synchronization message comprising the selected items,
   send the generated synchronization message to the second MTU.
6. An electronic restaurant management system comprising
   a first mobile terminal unit “MTU”,
   a second mobile terminal unit “MTU”, and
   a third mobile terminal unit “MTU”,
   the first, second and third MTUs comprising respective first, second and third local copies of a device list,
   the devices in the device list comprising the first, second and third MTU, and the devices in the device list being uniquely associated to a device rank,
   the first MTU being configured to run in a controller mode, the second MTU and the third MTU being configured to run in a client mode, the second MTU and the third MTU being operative to
   determine, by using the device list, that the first MTU is the current controller device,
   send controller query signals to the first MTU over a wireless connection and to
   wait for an acknowledgement message from the first MTU for a predetermined waiting time, and, if no acknowledgment message is received within the predetermined waiting time, to
   mark the first MTU in the respective local copy of the device list as unresponsive and to
   select a new controller device from the respective local copy of the device list, the new controller being the device that has the highest device rank among those devices that are not marked as unresponsive in the respective local copy of the device list.
7. An electronic restaurant management system according to item 6, wherein the step of assigning a controller function is performed independently on the second MTU and the third MTU.
8. An electronic restaurant management system, wherein the second MTU and the third MTU are operative to
   exchange messages after the step of assigning a controller function, the messages enabling the second MTU and the third MTU to detect if the new controller assigned by the second MTU is identical to the new controller assigned by the third MTU.
9. A method for setting up a first mobile device in a restaurant management system, comprising
   receiving an instruction to run in an operation mode, the operation mode being related to a user specific task of the restaurant management system,
   sending a synchronization message to a second mobile device, the second mobile device being configured to run in a controller mode, the synchronization message comprising a data value indicating that the first mobile device is in an unsynchronized state.

This data value may, in particular be provided by a synchronization time “00:00”, representing a lowest time value.
10. The method according to item 9, comprising at the second mobile device:
   receiving the synchronization message of the first mobile device and, in response to the data value,
   generating a second synchronization message, the second synchronization message comprising all data entries of a dish order list from the present day,
   sending the second synchronization message back to the first mobile device.

Herein, the selection comprises the entries with an entry data of the present day. If the dish order list of the controller only contains data entries of the present day, this may comprise selecting all entries, which need not comprise a date value in this case. This may be achieved by a backup routine of the mobile device, the backup routine removing the data entries of previous day after a completed backup.

The embodiments can also be described with the following lists of features or elements being organized into an item list. The respective combinations of features, which are disclosed in the item list, are regarded as independent subject matter, respectively, that can also be combined with other features of the application.
1. A method for synchronizing a dish order list in a computer network of a restaurant management system, comprising
   receiving an order for a selected dish by receiving a user selection from a menu list,
   storing the user selection in a client dish order list of a first mobile client device,
   sending a synchronization message from the first mobile client device to a mobile controller device, the synchronization message comprising a synchronization time and one or more entries of a dish order list,
   receiving the synchronization message from the first mobile client device,
   updating a local copy of the dish order list based on the received synchronization message,
   generating an actualized synchronization time,
   retrieving a synchronization time of a second mobile client device,
   selecting entries from the local copy of the dish order list, the selection depending on the synchronization time of the second mobile client device and on the actualized synchronization time,
   generating a second synchronization message, the second synchronization message comprising the selected items, and
   sending the second synchronization message to the second mobile client device.
2. The method of item 1, further comprising
   receiving acknowledgment messages from mobile client devices in a device list for which the second synchronization message has been sent, and
   updating the synchronization time for those mobile client devices for which acknowledgement messages have been received.
3. The method of item 2, further comprising
   if no acknowledgement message has been received from a client device within a predetermined time:
      marking a corresponding entry in the device list as inactive,
      generating an alert message, and
      sending the alert message.
4. A computer program code for executing the method according to one of the items 1 to 3, the computer program code comprising a graphical user interface “GUI”, and the computer program code providing a configuration option to display a task specific GUI, the task being a user-specific task in a restaurant management system.
5. A computer program code according to item 4, wherein the task is selected from a waiter task, a dish order task, a restaurant customer task, a cooking management task, and a cashier task.
6. A computer program code according to one of the items 4 to 5, the computer program code being adapted for execution on a handheld computer device.
7. A software application for execution on a handheld computing device, the software application comprising the computer program code according to one of the items 4 to 6, and the software application providing an interface for installing the software application on the handheld computing device.
8. A computer readable storage medium, the computer readable storage medium comprising the computer program code according to one of the items 5 to 7.
9. A method for determining a controller mobile terminal unit “MTU” in a computer network of a restaurant management system with a plurality of handheld devices, comprising
   providing a device list on each of the handheld devices, the device list comprising identifiers of the handheld devices,
   determining a current controller device from among the devices of the device list,
   determining if the current controller device of the device list is responsive, and
   if it is determined that the current controller device is not responsive:
   determining a new controller device according to a device rank that is uniquely associated with each entry in the device list.
10. The method of item 9, the determination if a current controller device is responsive comprising
   broadcasting a controller query message in predetermined time intervals,
   waiting for an acknowledgment message for a predetermined waiting time, and
   if no acknowledgement message is received within the predetermined waiting time:
   determining that the current controller is not responsive.
11. The method according to item 9 or item 10, further comprising identifying the next controller by selecting the device with the next highest device rank from the device list.
12. The method according to one of the items 9 to 11, further comprising identifying the next controller by selecting a device with the next highest device rank from the device list, and, if the new controller device is identical to a current device on which the selection step is executed,
   setting up the current device as a controller, the set-up including
   updating the device list.
13. A computer readable code for executing a method according to one of the items 9 to 12 on a handheld computer.
14. A computer readable storage medium, the computer readable storage medium comprising the computer readable code according to item 13.
15. A mobile device for a restaurant management system, comprising
   a display,
   an input means,
   a wireless communication means,
   a computer readable memory, the computer readable memory comprising
      a client dish order list, and
      a predetermined menu list, and
   a computing means, wherein the display, the input means, the wireless communication means and the computer readable memory are connected to the computing means, and wherein the mobile device is operative to
   receive an order for a selected dish by receiving a user selection from the menu list,
   store the user selection in the client dish order list,
   generate a first synchronization message, the first synchronization message comprising a first synchronization time and one or more first entries of the client dish order list,
   and wherein the mobile device is operative to
   receive a second synchronization message, the second synchronization message comprising a second synchronization time and one or more second entries of a controller dish order list, and
   update the client dish order list based on the received second synchronization message.
16. A restaurant management system with at least a first mobile device according to item 15 and a second mobile device according to item 15, the first and the second mobile device being configured to exchange synchronization messages over a computer network, wherein the first and the second mobile device each comprise a device list, and wherein the first and the second mobile device are configured to determine a controller device according to a device ranking in the device list.
17. A mobile device for a restaurant management system, comprising
   a display,
   an input means,
   a wireless communication means,
   a computer readable memory, the computer readable memory comprising
      a controller dish order list, and
      a device list, and
   a computing means, the display, the input means, the wireless communication means and the computer readable memory being connected to the computing means, wherein the mobile device is operative to
   receive a first synchronization message, the first synchronization message comprising a first synchronization time and one or more order entries of a first client dish order list,
   update the controller dish order list based on the received first synchronization message,
   generate a current timestamp,
   select zero or more entries from the controller dish order list based on the current timestamp and the received first synchronization time, and
   generate a second synchronization message comprising the current timestamp and the selected entries of the controller dish order list.
18. A restaurant management system with at least a first mobile device according to item 17 and a second mobile device according to item 17, wherein the first and the second mobile device are configured to exchange synchronization messages over a computer network, and wherein the first and the second mobile device are configured to determine a controller device according to a device ranking in the device list.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practise. Thus, the scope of the embodiments should be determined by the claims and their equivalents, rather than by the examples given.

REFERENCE

| | | | |
|---|---|---|---|
| 8 | table | 41 | synchronization times |
| 9 | table | 51 | network group 1 |
| 10 | restaurant management | 52 | network group 2 |
| | system | 53 | cloud server |
| 11 | restaurant area | 60-69: | method steps FIG. 6 |
| 12-18 | mobile terminal | 75-81: | method steps FIG. 7 |
| | units | 90 | MTU |
| 19 | wireless connection | 91 | communication unit |
| 20 | network router | 92 | microprocessor |
| 21 | WLAN network | 94 | USB socket |
| 22 | guest area | 95 | antenna |
| 23 | waiters | 96 | program memory |
| 24 | cashiers | 97 | data memory |
| 25 | cashier area | 99 | customer feedback |
| 26 | cooks | | module |
| 27 | cooking area | 100 | cashier module |
| 28 | cooking places | 101 | cooking management |
| 30 | supervisor computer | | module |
| 32 | order list | 104 | waiter submodule |
| 33 | order IDs | 103 | controller assignment |
| 34 | order synch times | 104 | table layout |
| 35 | menu list | 106 | touch screen area |
| 36 | dish IDs | 107 | control panel |
| 37 | dish info | 110-126: | method steps of |
| 38 | MTU list | | FIGS. 11 and 12 |
| 39 | client IDs | 200 | Internet |

1. A method for synchronizing a dish order list in a computer network of a restaurant management system, comprising
receiving an order for a selected dish by receiving a user selection from a menu list,
storing the user selection in a client dish order list of a first mobile client device,
sending a synchronization message from the first mobile client device to a mobile controller device, the synchronization message comprising a synchronization time and one or more entries of a dish order list,
receiving the synchronization message from the first mobile client device,
updating a local copy of the dish order list based on the received synchronization message,
generating an actualized synchronization time,
retrieving a synchronization time of a second mobile client device,
selecting entries from the local copy of the dish order list, the selection depending on the synchronization time of the second mobile client device and on the actualized synchronization time,
generating a second synchronization message, the second synchronization message comprising the selected items, and
sending the second synchronization message to the second mobile client device.

2. The method of claim 1, further comprising
receiving acknowledgment messages from mobile client devices in a device list for which the second synchronization message has been sent, and
updating the synchronization time for those mobile client devices for which acknowledgement messages have been received.

3. The method of claim 2, further comprising
if no acknowledgement message has been received from a client device within a predetermined time:
marking a corresponding entry in the device list as inactive,
generating an alert message, and
sending the alert message.

4. A computer program code for executing the method according to claim 1, the computer program code comprising a graphical user interface “GUI”, and the computer program code providing a configuration option to display a task specific GUI, the task being a user-specific task in a restaurant management system.

5. A computer program code according to claim 4, wherein the task is selected from a waiter task, a dish order task, a restaurant customer task, a cooking management task, and a cashier task.

6. A computer program code according to claim 4, the computer program code being adapted for execution on a handheld computer device.

7. A software application for execution on a handheld computing device, the software application comprising the computer program code according to claim 4, and the software application providing an interface for installing the software application on the handheld computing device.

8. A computer readable storage medium, the computer readable storage medium comprising the computer program code according to claim 5.

9. A method for determining a controller mobile terminal unit “MTU” in a computer network of a restaurant management system with a plurality of handheld devices, comprising
providing a device list on each of the handheld devices, the device list comprising identifiers of the handheld devices,
determining a current controller device from among the devices of the device list,
determining if the current controller device of the device list is responsive, and
if it is determined that the current controller device is not responsive:
determining a new controller device according to a device rank that is uniquely associated with each entry in the device list.

10. The method of claim 9, the determination if a current controller device is responsive comprising
broadcasting a controller query message in predetermined time intervals,
waiting for an acknowledgment message for a predetermined waiting time, and
if no acknowledgement message is received within the predetermined waiting time:
determining that the current controller is not responsive.

11. The method according to claim 9, further comprising identifying the next controller by selecting the device with the next highest device rank from the device list.

12. The method according to claim 9, further comprising identifying the next controller by selecting a device with the next highest device rank from the device list, and, if the new controller device is identical to a current device on which the selection step is executed,
setting up the current device as a controller, the set-up including
updating the device list.

13. A computer readable code for executing a method according to claim 9 on a handheld computer.

14. A computer readable storage medium, the computer readable storage medium comprising the computer readable code according to claim 13.

15. A mobile device for a restaurant management system, comprising
a display,
an input means,
a wireless communication means,
a computer readable memory, the computer readable memory comprising
a client dish order list,
a predetermined menu list, and
a computing means,
wherein the display, the input means, the wireless communication means and the computer readable memory are connected to the computing means, and wherein the mobile device is operative to
receive an order for a selected dish by receiving a user selection from the menu list,
store the user selection in the client dish order list,
generate a first synchronization message, the first synchronization message comprising a first synchronization time and one or more first entries of the client dish order list,
and wherein the mobile device is operative to
receive a second synchronization message, the second synchronization message comprising a second synchronization time and one or more second entries of a controller dish order list, and
update the client dish order list based on the received second synchronization message.

16. A restaurant management system with at least a first mobile device according to claim 15 and a second mobile device according to claim 15, the first and the second mobile device being configured to exchange synchronization messages over a computer network,
wherein the first and the second mobile device each comprise a device list, and wherein the first and the second mobile device are configured to determine a controller device according to a device ranking in the device list.

17. A mobile device for a restaurant management system, comprising
a display,
an input means,
a wireless communication means,
a computer readable memory, the computer readable memory comprising
a controller dish order list,
a device list, and
a computing means, the display, the input means, the wireless communication means and the computer readable memory being connected to the computing means, wherein the mobile device is operative to
receive a first synchronization message, the first synchronization message comprising a first synchronization time and one or more order entries of a first client dish order list,
update the controller dish order list based on the received first synchronization message,
generate a current timestamp,
select zero or more entries from the controller dish order list based on the current timestamp and the received first synchronization time, and
generate a second synchronization message comprising the current timestamp and the selected entries of the controller dish order list.

18. A restaurant management system with at least a first mobile device according to claim 17 and a second mobile device according to claim 17, wherein the first and the second mobile device are configured to exchange synchronization messages over a computer network, and wherein the first and the second mobile device are configured to determine a controller device according to a device ranking in the device list.
